(19) United States
(12) Patent Application Publication
(10) Pub. No.: US 2021/0073396 A1
(43) Pub. Date: Mar. 11, 2021

(54) System and Method for Secure Image Embeddings

(71) Applicant: Everalbum, Inc., San Francisco, CA (US)

(72) Inventor: Charles Edward Rice, Greenbrae, CA (US)

(73) Assignee: Everalbum, Inc., San Francisco, CA (US)

(21) Appl. No.: 17/013,152

(22) Filed: Sep. 4, 2020

Related U.S. Application Data
(60) Provisional application No. 62/896,451, filed on Sep. 5, 2019.

(51) Int. Cl. G06F 21/60; G06K 9/00; G06F 16/53; G06F 16/56; G06F 16/51; H04L 9/06; G06F 7/575

(52) U.S. Cl. CPC G06F 21/602; G06K 9/00885; G06F 16/53; G06K 2009/00953; G06F 16/51; H04L 9/0631; G06F 7/575; G06F 16/56

(57) ABSTRACT

Systems and methods for secure image embeddings in accordance with embodiments of the invention are illustrated. One embodiment includes a method for storing image embedding data. The method includes steps for generating an image embedding vector, performing a set of one or more obfuscation methods on the generated image embedding vector to generate an obfuscated image embedding, and storing the obfuscated image embedding vector.

### CROSS-REFERENCE TO RELATED APPLICATIONS

The current application claims priority to U.S. Provisional Patent Application No. 62/896,451, filed Sep. 5, 2019, the disclosure of which is hereby incorporated by reference in its entirety.

### FIELD OF THE INVENTION

The present invention generally relates to image embeddings and, more specifically, the for storage and querying of secure image embeddings.

### BACKGROUND

Digital images are used in a variety of different applications, such as for facial recognition, security applications, image search, etc. The ability to securely store and/or search across such images is becoming increasingly important.

### SUMMARY OF THE INVENTION

Systems and methods for secure image embeddings in accordance with embodiments of the invention are illustrated. One embodiment includes a method for storing image embedding data. The method includes steps for generating an image embedding vector, performing a set of one or more obfuscation methods on the generated image embedding vector to generate an obfuscated image embedding, and storing the obfuscated image embedding vector.

In a further embodiment, the set of obfuscation methods includes reordering elements of the image embedding vector.

In still another embodiment, reordering the elements of the image embedding vector comprises identifying an offset value, and rearranging a first and second portion of the image embedding vector based on the offset value.

In a still further embodiment, the offset value is encrypted, wherein reordering the image embedding vector further includes decrypting the offset value.

In yet another embodiment, the set of obfuscation methods includes obfuscating elements of the image embedding vector using an obfuscation vector.

In a yet further embodiment, obfuscating the elements includes performing an operation on elements of the image embedding vector based on elements of the obfuscation vector.

In another additional embodiment, the operation includes one of multiplication, division, addition, and subtraction.

In a further additional embodiment, the set of obfuscation methods includes padding the image embedding vector.

In another embodiment again, padding the image embedding vector includes inserting random values into the image embedding vector.

In a further embodiment again, the method further includes steps for identifying an operation order, wherein performing the set of obfuscation methods includes performing a plurality of obfuscation methods in the operation order.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example of a system for securing image embeddings in accordance with an embodiment of the invention.

FIG. 2 illustrates an example of a secure image embedding element in accordance with an embodiment of the invention.

FIG. 3 illustrates an example of a secure image embedding application in accordance with a number of embodiments of the invention.

FIG. 4 conceptually illustrates a process for storing secured image embeddings in accordance with an embodiment of the invention.

FIG. 5 conceptually illustrates a process for querying secure image embeddings in accordance with an embodiment of the invention.

FIGS. 6-9 illustrate examples of obfuscation processes in accordance with some embodiments of the invention.

### DETAILED DESCRIPTION

Turning now to the drawings, systems and methods for generating secure image embeddings (also referred to as image vectors or feature vectors) are described below. In many embodiments, securing image embeddings allow for the secure storage and retrieval of information such as (but not limited to) images, personal information, and account data. In many embodiments, the storage and querying based on secure image embeddings allows for the storage of secure embeddings based on an initial target image and querying against the secure embeddings based on subsequent query images. The storage of secure image embeddings can allow for the storage of information without any identifying information, such as a name or user identification.

In a number of embodiments, secure image embeddings can be used across multiple data managers, where each data manager maintains a separate obfuscation key (or a set of one or more obfuscation methods) for obfuscating all of the image embeddings stored by the data manager. Separate obfuscation keys can hinder attacks between data managers because compromising a first data manager, whether at a client or at a server, doesn't compromise the secured image embeddings for a second data manager.

In many embodiments, secure image embeddings allow a user to maintain their privacy. In some cases, attacks on a system can allow an attacker to gather information about a user's images based on image vectors generated by the system. By securing the image vectors, whether in transit and/or in storage, the secured image vectors can help to hinder attacks based on unobfuscated feature vectors.

Secure image embeddings in accordance with several embodiments of the invention allow for the secured querying of a database for a variety of purposes, such as (but not limited to) performing an image search for similar images, authenticating a user based on images of the user, and/or retrieving personal information for a user.

Image embeddings in accordance with many embodiments of the invention can specify features of an image across multiple dimensions. In some embodiments, image embeddings can identify a point in multi-dimensional space, allowing for a query to be run based on the nearness of an image embedding with a target image embedding within the multi-dimensional space. For example, in certain embodiments image embeddings include feature vectors of a user's face, and the results of a query are identified based on the nearness of a query vector with a target vector. Nearness between vectors can be measured in a variety of ways such as (but not limited to) a Euclidean (L2) distances. As can readily be appreciated, any of a variety of distance metrics can be utilized to determine the distance between two multi-dimensional feature vectors in feature space as appropriate to the requirements of a specific application in accordance with various embodiments of the invention.

### Systems for Secure Image Embeddings

Secure Image Embedding System

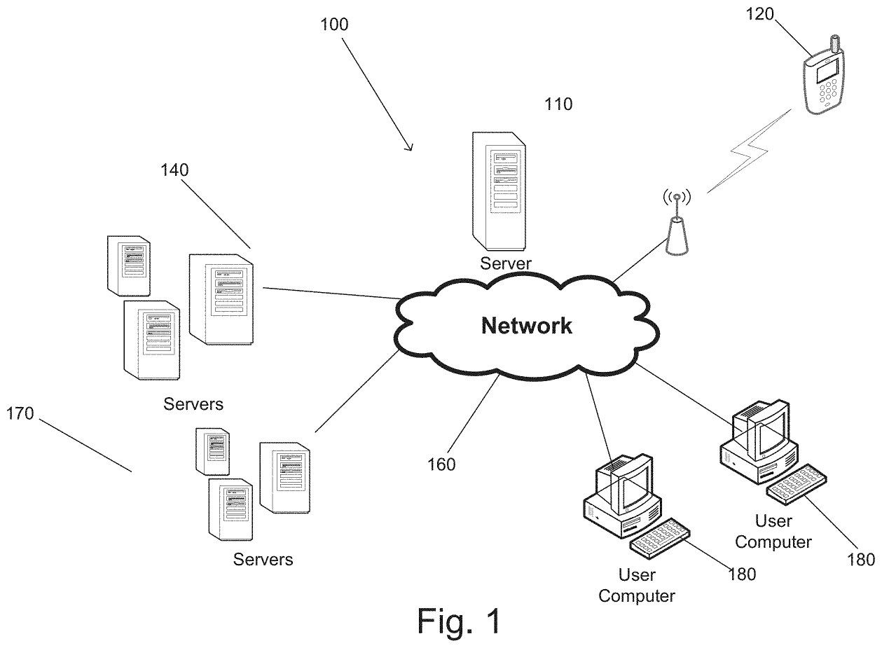

A system for securing image embeddings in accordance with some embodiments of the invention is illustrated in FIG. 1. Network 100 includes a communications network 160. The communications network 160 is a network such as the Internet that allows devices connected to the network 160 to communicate with other connected devices. Server systems 110, 140, and 170 are connected to the network 160. Each of the server systems 110, 140, and 170 is a group of one or more servers communicatively connected to one another via networks that execute processes that provide cloud services to users over the network 160. For purposes of this discussion, cloud services are one or more applications that are executed by one or more server systems to provide data and/or executable applications to devices over a network. The server systems 110, 140, and 170 are shown each having three servers in the internal network. However, the server systems 110, 140 and 170 may include any number of servers and any additional number of server systems may be connected to the network 160 to provide cloud services. In accordance with various embodiments of this invention, securing image embeddings can be provided by executing one or more processes on a single server system and/or a group of server systems communicating over network 160.

Users may use personal devices 180 and 120 that connect to the network 160 to perform processes for capturing images (or video), securing image embeddings, and/or retrieving information based on secured image embeddings with various embodiments of the invention. In the illustrated embodiment, the personal devices 180 are shown as desktop computers that are connected via a conventional “wired” connection to the network 160. However, the personal device 180 may be a desktop computer, a laptop computer, a smart television, an entertainment gaming console, or any other device that connects to the network 160 via a “wired” and/or “wireless” connection. Personal devices in accordance with many embodiments of the invention include an image capture device (e.g., webcam, camera, etc.) for recording images to be used for storing and/or retrieving secured image embeddings. Image capture devices in accordance with certain embodiments of the invention include a set of one or more image capture devices that can be used to capture video data of a user in motion. Given a single-camera or a multi-camera data collection setting, systems in accordance with a number of embodiments of the invention can use artificial neural networks (such as, but not limited to, convolutional neural networks) for extracting image embeddings from one or more images.

The mobile device 120 connects to network 160 using a wireless connection. A wireless connection is a connection that uses Radio Frequency (RF) signals, Infrared signals, or any other form of wireless signaling to connect to the network 160. In FIG. 1, the mobile device 120 is a mobile telephone. However, mobile device 120 may be a mobile phone, Personal Digital Assistant (PDA), a tablet, a smartphone, or any other type of device that connects to network 160 via a wireless connection without departing from this invention. In many embodiments, an application being executed by the user device may capture or obtain images of a user and transmit the images to a server system that performs additional processing (such as, but not limited to, generating secure image embeddings) based upon the received images. In a number of embodiments, secure image embeddings are generated at a personal device and the secure image embeddings are transmitted to a server system to be stored and/or to perform a search based on the secure image embeddings. Although references are made to images throughout this application, one skilled in the art will recognize that processes described in this application can clearly be applied to video (or video frames) without departing from this invention.

Secure Image Embedding Element

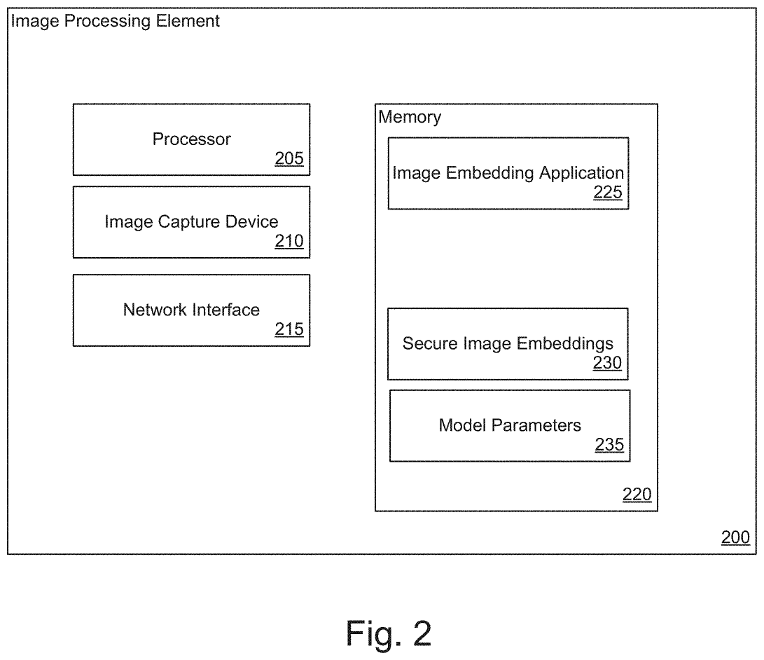

An example of a secure image embedding element in accordance with an embodiment of the invention is illustrated in FIG. 2. In some embodiments, secure image embedding elements can allow for the secure storage of image embeddings and/or the querying of information based on secured image embeddings. Secure image embedding elements in accordance with certain embodiments of the invention can include (but are not limited to) servers that provide a service to clients, client devices that communicate with potentially unsecured data storages, and/or data managers that operate between clients and servers to obfuscate the storage and querying of data.

Secure image embedding element 200 includes a processor 205, image capture device 210, network interface 215, and memory 220. One skilled in the art will recognize that a particular image processing element may include other components that are omitted for brevity without departing from this invention. The processor 205 can include (but is not limited to) a processor, microprocessor, controller, or a combination of processors, microprocessor, and/or controllers that performs instructions stored in the memory 220 to manipulate data stored in the memory. Processor instructions can configure the processor 205 to perform processes in accordance with certain embodiments of the invention. Image capture device 210 can capture and/or retrieve images for the motion evaluation element. Image capture devices can include (but are not limited to) cameras and other sensors that can capture image data of a scene. Network interface 215 allows secure image embedding element 200 to transmit and receive data over a network based upon the instructions performed by processor 205.

Memory 220 includes a secure image embedding application 225, secure image embeddings 230, and model parameters 235. Secure image embedding applications in accordance with several embodiments of the invention are used to generate secure image embeddings based on a model trained using model parameters and/or weights to generate image embeddings from a set of one or more images.

Although a specific example of a secure image embedding element 200 is illustrated in FIG. 2, any of a variety of secure image embedding elements can be utilized to perform processes similar to those described herein as appropriate to the requirements of specific applications in accordance with embodiments of the invention.

Secure Image Embedding Application

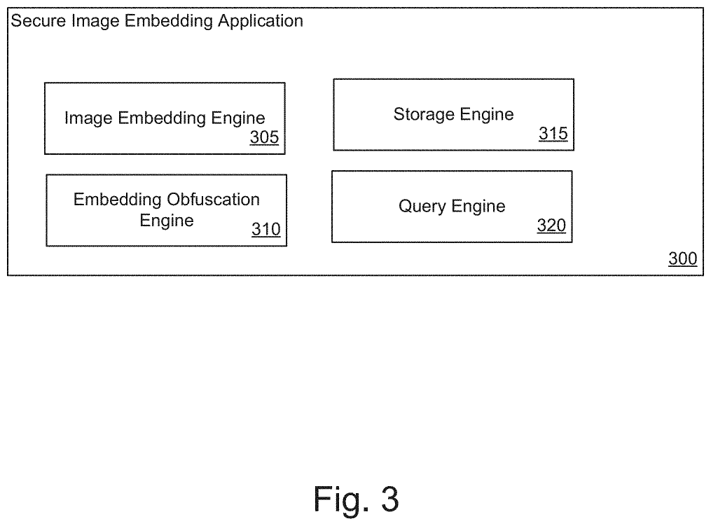

A secure image embedding application in accordance with a number of embodiments of the invention is illustrated in FIG. 3. Secure image embedding application 300 includes image embedding engine 305, embedding obfuscation engine 310, storage engine 315, and query engine 320. In many embodiments, secure image embedding applications operate on mobile devices to provide for secured transmission of obfuscated image embeddings across a network.

Image embedding engines in accordance with many embodiments of the invention are for generating image embeddings (e.g., feature vectors) that represent features of an image. Image embedding engines in accordance with certain embodiments of the invention apply one or more machine learning models (such as, but not limited to convolutional neural networks) to identify features from a set of images. In many embodiments, machine learning models can be trained to classify the identities of faces found in images, training the models to identify features that are useful for distinguishing between different individuals. The images can include a target set of images that can be used to match against future searches and/or a query set of images that can be used to search against a database of target image embeddings.

Embedding obfuscation engines in accordance with several embodiments of the invention can be used to obfuscate the generated image embeddings to secure the storage of such image embeddings and/or the querying of a datasource of secure image embeddings from target images based on a set of one or more query images. In some embodiments, obfuscation engines can be implemented using one or more methods, such as (but not limited to) matrix multiplication and vector padding.

In various embodiments, embedding obfuscation engines are also used for reverting some or all of the obfuscations performed on a secured image embedding. For example, embedding obfuscation engines in accordance with a number of embodiments of the invention can remove padded elements from a secured image vector, prior to storage or querying, while maintaining the reordered or masked values of the secure image embedding. In this manner, an image embedding can be provided by a client using additional transport security by using a shared secret (e.g., the location of the true values of the image embedding) with a server, while also maintaining the security of the image embeddings through the remaining obfuscations (e.g., reordering and/or masking of elements), even if the server itself is compromised.

Storage engines in accordance with several embodiments of the invention can be used to store obfuscated vectors in a storage for future retrieval or searching. In many embodiments, the storage engines communicate over a network to store secured image embeddings remotely, such as (but not limited to) at a server and/or cloud service.

In a number of embodiments, query engines can use obfuscated image embeddings of a query image to query against a database of secured image embeddings of target images. Query engines in accordance with some embodiments of the invention provide the queried results for a user. Queried results can include a number of nearest matches (e.g., in the case of a related image search) or may only return a result when the nearest match is within a particular threshold, such as in the case of user authentication.

Although a specific example of a secure image embedding application is illustrated in FIG. 3, any of a variety of secure image embedding elements can be utilized to perform processes similar to those described herein as appropriate to the requirements of specific applications in accordance with embodiments of the invention.

Methods for Secure Image Embedding

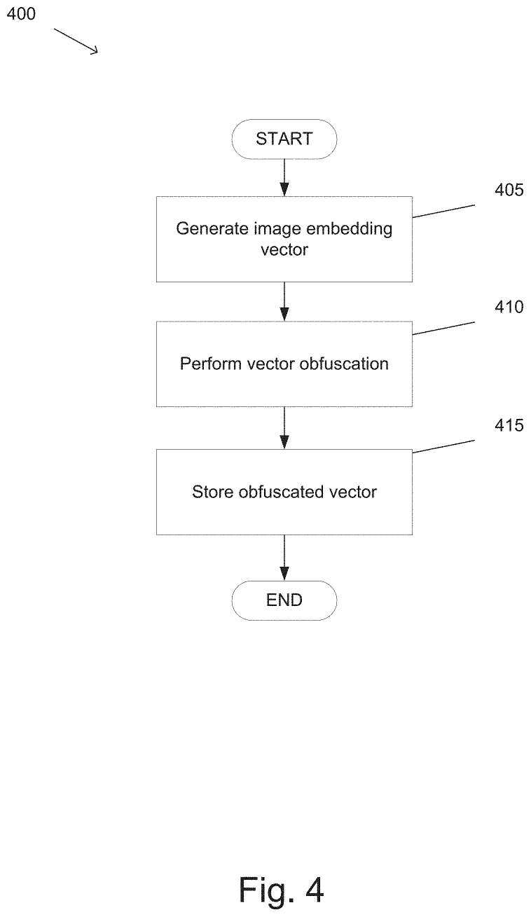

A process for securing image embeddings in accordance with a number of embodiments of the invention is described with reference to FIG. 4. Processes for securing image embeddings in accordance with many embodiments of the invention can be performed at a client device and/or at a server. Process 400 generates (405) an image embedding vector. Image embedding vectors in accordance with some embodiments of the invention are compact representations of features identified in an image. In some embodiments, image embedding vectors (or feature vectors) are generated using a convolutional neural network based on an image, which can represent these identifying characteristics as a multi-dimensional vector (e.g., a 1024 dimensional vector) of values, or a set of image embeddings. Images in accordance with several embodiments of the invention can include images from a variety of sources, including (but not limited to) images stored on a server, captured by an image capture device, and/or received from another device.

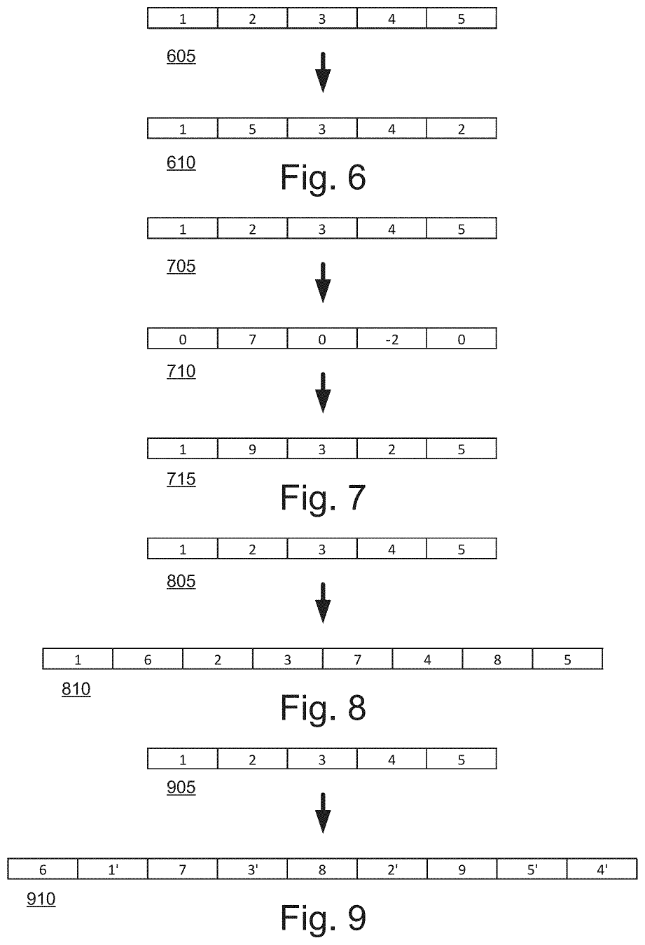

Process 400 performs (410) vector obfuscation on the generated image embedding vector. Vector obfuscation in accordance with many embodiments of the invention can include (but is not limited to) reordering elements of the vector, masking elements of the vector, and/or increasing the length of the vector with pad elements. Vector obfuscation is described in greater detail below with reference to FIGS. 6-9. In some embodiments, each data manager has an obfuscation key that defines the parameters for the obfuscation. Obfuscation keys in accordance with a variety of embodiments of the invention specify an order of operations, masking vectors, and/or a reordering of the elements of a vector.

Process 400 stores (415) the obfuscated image embedding vectors. In some embodiments, image embedding vectors are stored in a database with an identity such as (but not limited to) a name, social security number, and/or customer number for later retrieval. Obfuscated image embedding vectors in accordance with certain embodiments are created at a client device and stored at a set of servers. In some embodiments, obfuscated image embedding vectors are stored as part of a registration process for registering users within a system.

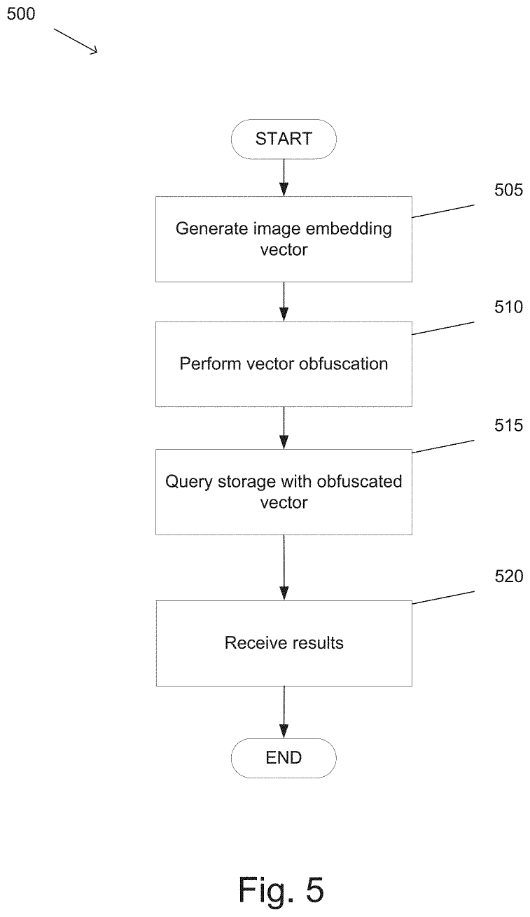

Once secured image embeddings have been stored, processes in accordance with a number of embodiments of the invention can search for a secured image embedding based on either the same image or based on a similar image. A process for searching secured image embeddings is described with reference to FIG. 5. Processes for querying secured image embeddings in accordance with many embodiments of the invention can be performed at a client device and/or at a server. Process 500 generates (505) an image embedding vector. Image embedding vectors in accordance with some embodiments of the invention are compact representations of features identified in an image. In some embodiments, image embedding vectors (or feature vectors) are generated using a convolutional neural network based on an image, which can represent these identifying characteristics as a multi-dimensional vector (e.g., a 1024 dimensional vector) of numbers also known as a feature vector, or a set of face embeddings. Images in accordance with several embodiments of the invention can include various images including (but not limited to) images stored on a server, captured by an image capture device, and/or received from another device.

Process 500 performs (510) vector obfuscation on the generated image embedding vector. Vector obfuscation in accordance with many embodiments of the invention can include (but is not limited to) reordering elements of the vector, masking elements of the vector, and/or increasing the length of the vector with pad elements. Vector obfuscation is described in greater detail below with reference to FIGS. 6-9. In a variety of embodiments, vector obfuscation is performed based on an obfuscation key that is unique to various data managers within a system. Obfuscation keys in accordance with certain embodiments of the invention can include multiple components, such as (but not limited to) an order of operations, masking vectors, a reordering of vector elements, and/or a mapping of true values from a padded vector.

Process 500 queries (515) a datasource using the obfuscated image embedding vectors. In some embodiments, image embedding vectors are used as an index for retrieving information stored in a database such as (but not limited to) a name, social security number, and/or customer number for later retrieval.

Process 500 receives (520) results based on the query. In some embodiments, the received results can include a number of nearest matches (e.g., in the case of a related image search) or may only return a result when the nearest match is within a particular threshold, such as in the case of user authentication.

For example, in accordance with many embodiments of the invention methods for securing face embeddings while maintaining searchability may include receiving a request from a computing device to search a database of known identities based on an image and using a deep neural network to convert the image to a 128-1024 dimension vector of numbers. Methods can further include using a first secret key to obscure the original values for each dimension of the vector, using a second secret key to randomize the order of the numbers in the vector, and/or using a third secret key to pad the resulting vector with random variables to a determined length. Methods can include using the transformed vector to search a database of known identities by calculating the distance between the newly created vector and the vectors stored in a database, and returning the stored vector that is the closest match to the new set as a match.

Methods in accordance with some embodiments of the invention can be used to help prevent several common attacks. First, secured image embeddings can prevent embeddings from one data manager's database from being inserted into the database of a second data manager's database. Second, they can prevent a brute force attack where an attacker uses a known image of person to find the face embeddings in an identity database of a data manager. Third, they can prevent an attacker from changing the face embeddings of person A to match person B.

In various embodiments, secure image embedding processes can operate on any of a variety of devices (such as (but not limited to) servers, client devices, mobile devices, and cloud services). Processes in accordance with some embodiments of the invention can be distributed across multiple devices at multiple points in the process. For example, in accordance with some embodiments of the invention image embeddings are obfuscated using a first obfuscation key specific to a data manager and a different, second obfuscation key specific to a service provider, allowing data to remain searchable, but still providing protection in the case that either the service provider or the data manager are compromised.

Image Embedding Obfuscation

Image embedding vectors can be obfuscated in a variety of different manners in accordance with many embodiments of the invention. In some embodiments, image embedding obfuscations can include (but are not limited to) one or more of reordering of the elements, masking of the elements, and/or inserting dummy elements into the image embedding.

An example of reordering an image embedding is illustrated in FIG. 6. The first vector 605 shows elements 1-5. The second vector 610 shows that the elements 1-5 have been reordered. In a variety of embodiments, various methods are specified for reordering image embeddings. Obfuscation keys in accordance with certain embodiments of the invention can include (but are not limited to) a function that can be used to randomize the order of the elements of image embeddings and/or an order vector that indicates the correct order of a reordered image embedding.

In some embodiments, image embeddings can be reordered based on an offset value. In certain embodiments, offset values represent an offset that was used in storing a vector. For example, with a vector [0-511], an offset value of 255 can represent that the vector has been stored as [256-511, 0-255]. A vector with an offset value of 128 may be stored as [128-511, 0-127]. In some such embodiments, the vector can be viewed as a circle or chain of numbers, where the way that the vector is stored depends on the offset value stored with the vector (e.g., {offset value},{face embedding vector}). Offset values in accordance with some embodiments of the invention can be generated in a variety of ways, such as (but not limited to) random number generation. Offset values in accordance with many embodiments of the invention can be encrypted values, where the offset value is encrypted in any of a variety of ways including (but not limited to) a 256-bit advanced encryption standard (AES) cipher. In several embodiments, offset values can be used with various elements including (but not limited to) image embeddings, order vectors, obfuscation vectors, etc.

An example of masking elements of an image embedding is illustrated in FIG. 7. The first vector 705 shows elements 1-5. The second vector 710 shows a masking vector that can be used to mask elements of the image vector 705 to generate an obfuscated vector 715. Masking vectors in accordance with some embodiments of the invention can be added, subtracted, multiplied, and/or divided against an image embedding vector to generate obfuscated vectors. In some embodiments, masking vectors include a masking value for each element, while masking vectors in accordance with other embodiments of the invention can only include masking values for a subset of the elements. In various embodiments, when multiple data managers use a particular service provider to store secured image embeddings, the service provider can generate a different set of vector masks (or other obfuscation key elements) for each data manager. In many embodiments, rather than masking vectors, processes can provide a function which transforms the value of each number in a 128-1024 dimension vector. The transformation is unique to each place in the vector. For example, if the vector is a set of 512 numbers, the transformation can use a unique set of 512 (or fewer) random numbers to transform the values of each individual dimension.

An example of inserting dummy elements into the image embedding is illustrated in FIG. 8. The first vector 805 shows elements 1-5. The second vector 810 shows that the elements 1-5 remain, but also that other dummy elements 6-8 have been interspersed between the true elements of the feature vector. In some embodiments, the dummy elements (or pad elements) are randomly generated elements that are used to further prevent an attacker from identifying the true image vector.

Another example of an obfuscated image embedding is illustrated in FIG. 9. In this example, a combination of obfuscation methods is performed on image embedding 905 to generate obfuscated embedding 910. In some embodiments, the obfuscation key includes an order of operations, defining not only which obfuscations are to be performed, but the order of the operations as well. Obfuscation keys in accordance with some embodiments of the invention can specify multiple applications of the same operation. In various embodiments, obfuscation methods can be performed not only on the image embedding, but also on other vector elements of the obfuscation process, such as (but not limited to) order vectors and obfuscation vectors.

Although a specific examples of image embedding obfuscations are illustrated in FIGS. 6-9, any of a variety of obfuscations can be utilized to perform processes similar to those described herein as appropriate to the requirements of specific applications in accordance with embodiments of the invention.

### Applications of Secure Image Embeddings

The securing of image embeddings can have many different applications in various industries. For example, secure image embeddings can be used for authentication of users, in which images or video of a user can be used to authenticate a user's identity based on a previously stored, secure facial embedding. Secure image embeddings in accordance with various embodiments of the invention can also be used to secure the transfer of facial embedding information without exposing the data directly.

Although specific methods of securing image embeddings are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for storing image embedding data, the method comprising:
generating an image embedding vector;
performing a set of one or more obfuscation methods on the generated image embedding vector to generate an obfuscated image embedding; and
storing the obfuscated image embedding vector.

2. The method of claim 1, wherein the set of obfuscation methods comprises reordering elements of the image embedding vector.

3. The method of claim 2, wherein reordering the elements of the image embedding vector comprises:
identifying an offset value; and
rearranging a first and second portion of the image embedding vector based on the offset value.

4. The method of claim 3, wherein the offset value is encrypted, wherein reordering the image embedding vector further comprises decrypting the offset value.

5. The method of claim 1, wherein the set of obfuscation methods comprises obfuscating elements of the image embedding vector using an obfuscation vector.

6. The method of claim 1, wherein obfuscating the elements comprises performing an operation on elements of the image embedding vector based on elements of the obfuscation vector.

7. The method of claim 1, wherein the operation comprises one of multiplication, division, addition, and subtraction.

8. The method of claim 1, wherein the set of obfuscation methods comprises padding the image embedding vector.

9. The method of claim 8, wherein padding the image embedding vector comprises inserting random values into the image embedding vector.

10. The method of claim 1 further comprising identifying an operation order, wherein performing the set of obfuscation methods comprises performing a plurality of obfuscation methods in the operation order.

11. A non-transitory machine readable medium containing processor instructions for storing image embedding data, where execution of the instructions by a processor causes the processor to perform a process that comprises:
generating an image embedding vector;
performing a set of one or more obfuscation methods on the generated image embedding vector to generate an obfuscated image embedding; and
storing the obfuscated image embedding vector.

12. The non-transitory machine readable medium of claim 11, wherein the set of obfuscation methods comprises reordering elements of the image embedding vector.

13. The non-transitory machine readable medium of claim 12, wherein reordering the elements of the image embedding vector comprises:
identifying an offset value; and
rearranging a first and second portion of the image embedding vector based on the offset value.

14. The non-transitory machine readable medium of claim 13, wherein the offset value is encrypted, wherein reordering the image embedding vector further comprises decrypting the offset value.

15. The non-transitory machine readable medium of claim 11, wherein the set of obfuscation methods comprises obfuscating elements of the image embedding vector using an obfuscation vector.

16. The non-transitory machine readable medium of claim 11, wherein obfuscating the elements comprises performing an operation on elements of the image embedding vector based on elements of the obfuscation vector.

17. The non-transitory machine readable medium of claim 11, wherein the operation comprises one of multiplication, division, addition, and subtraction.

18. The non-transitory machine readable medium of claim 18, wherein padding the image embedding vector comprises inserting random values into the image embedding vector.

19. The non-transitory machine readable medium of claim 11, wherein the process further comprises identifying an operation order, wherein performing the set of obfuscation methods comprises performing a plurality of obfuscation methods in the operation order.

20. A non-transitory machine readable medium containing processor instructions for storing image embedding data, where execution of the instructions by a processor causes the processor to perform a process that comprises:
generating an image embedding vector;
performing a plurality of obfuscation methods on the generated image embedding vector to generate an obfuscated image embedding, wherein performing the plurality of obfuscation methods comprises:
reordering the image embedding vector;
obfuscating elements of the image embedding vector; and
padding the image embedding vector; and
storing the obfuscated image embedding vector.
